(19) United States
(12) Patent Application Publication
(10) Pub. No.: US 2021/0132934 A1
(43) Pub. Date: May 6, 2021

(54) CLUSTER DEPLOYMENT

(71) Applicant: Bank of America Corporation, Charlotte, NC (US)

(72) Inventor: Srinivas Tatikonda, Hyderabad (IN)

(21) Appl. No.: 16/670,184

(22) Filed: Oct. 31, 2019

(51) Int. Cl. G06F 8/65; G06F 16/17

(52) U.S. Cl. CPC G06F 8/65; G06F 16/1734

(57) ABSTRACT

A system includes a deployment node and application nodes. The deployment node generates a master list of files associated with executing an application. The deployment node transmits the master list to the application nodes, which are configured to execute the application. A first application node receives the master list and determines a first file not available to the first application node by comparing the master list to a local file list. The local file list includes a record of files which are stored on and/or executed by the first application node. The first application node transmits, to the deployment node, a request for the first file. The deployment node receives the request and transmits the first file to the first application node. The first file is loaded into volatile memory of the first application node.

### TECHNICAL FIELD

The present disclosure relates generally to clustered environments. More particularly, in certain embodiments, the present disclosure is related to cluster deployment.

### BACKGROUND

A cluster refers to a collection of servers, or “nodes,” which are coupled together to perform a common computing task. There exists a need for improved systems and methods for operating clusters.

### SUMMARY

Applications may be deployed in clustered environments such that the processing tasks involved in executing an application are shared across multiple servers, or nodes. While clustered deployments of an application may provide certain benefits (e.g., improved scalability over non-clustered deployments), existing systems and methods for clustered application deployments suffer from several disadvantages. For instance, in conventional application deployments, each node involved in the deployment requires a copy of every file used to execute the application. Accordingly, if a change is made to the deployed application, a large number of files may need to be copied to each and every node of the deployment. This may involve the copying of thousands of files to tens, hundreds, or more of nodes. In some cases, some form of verification or acknowledgement must be sent/received to ensure that each file is successfully copied to each node. Accordingly, significant memory and processing resources may be expended to copy all of these files and perform the requisite verification and acknowledgment tasks to ensure the cluster executes the application correctly.

In one embodiment, a system includes a deployment node and application nodes. The deployment node generates a master list of files associated with executing an application. The deployment node transmits the master list to the application nodes, which are configured to execute the application. A first application node receives the master list and determines a first file not available to the first application node by comparing the master list to a local file list. The local file list includes a record of files which are stored on and/or executed by the first application node. The first application node transmits, to the deployment node, a request for the first file. The deployment node receives the request and transmits the first file to the first application node. The first file is loaded into volatile memory of the first application node.

The systems described in the present disclosure provide technical solutions to the technical problems of previous systems, including those described above, by facilitating more efficient and reliable deployment of applications in a clustered environment. The disclosed systems and methods provide several advantages which include 1) an efficient and effective application deployment system which automatically detects changes to a deployed application and propagates the changes to the various nodes of the cluster, 2) efficient updating of an application across multiple application nodes without repeated file copy operations, and 3) the facilitation of continued access to a cluster-based application while the deployment is updated at a separate deployment node that is separate from, but coupled to, the application cluster. As such, the system described in the present disclosure may improve the function of computer systems used for deploying applications in a clustered environment. The systems and methods may also reduce or eliminate technological bottlenecks to deploying updates to applications because there is significantly less down-time when a new deployment is configured. In other words, an older deployment of application can still be used while a developer makes changes to the application at a separate deployment node, which is used as a reference when each node of the application cluster is updated. The systems described in the present disclosure may be integrated into a variety of practical applications for updating application deployed in clustered environments.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example application deployment system;

FIG. 2 is a flow diagram illustrating operation of the example application deployment system of FIG. 1;

FIG. 3 is another flow diagram illustrating operation of the example application deployment system of FIG. 1; and

FIG. 4 is diagram illustrating an example device configured to implement the example application deployment system illustrated in FIG. 1.

### DETAILED DESCRIPTION

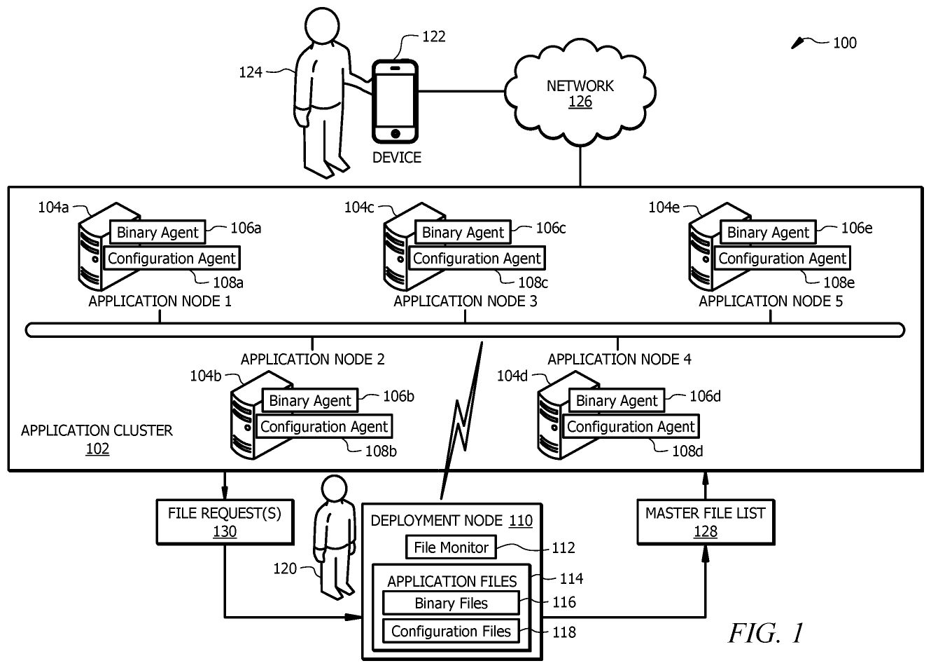

As described above, prior to the present disclosure, there was a lack of tools for efficiently and reliably deploying applications in a clustered environment. As described with respect to illustrative examples of FIGS. 1-4 below, the present disclosure facilitates improved deployment of applications in a clustered environment by detecting changes to an application and loading the appropriate files related to the changes directly into the volatile memory of each application node of the cluster. This facilitates efficient updates to a deployment of an application with little or no impact on user experience (e.g., with little or no “down-time” during which the deployed application is not available to users).

As used in this disclosure, volatile memory refers to the working memory of a computing device that is used to perform computing tasks. Volatile memory generally refers to memory which may be accessed relatively rapidly (e.g., as compared to non-volatile memory, such as read-only memory (ROM)). In some cases, volatile memory may be referred to as a cache or cached memory. For example, volatile memory may be random-access memory (RAM), dynamic random-access memory (DRAM), static random-access memory (SRAM), and the like.

### Example Application Deployment System

FIG. 1 is a diagram of an example application deployment system 100, according to an illustrative embodiment of this disclosure. The application deployment system 100 includes an application cluster 102, a deployment node 110, a computing device 122, and a network 126. The application may be, for example a web application, a database application, a data analysis application, or the like. The application deployment system 100 is generally configured to facilitate the efficient deployment of an application (i.e., via application files 114) in the application cluster 102. The deployment node 110 generally acts as a reference such that all files 114 required to execute a given deployment of an application are stored on the deployment node 110 and automatically propagated, as necessary, into the working memory (i.e., the volatile memory) of the application nodes 104a-c of the application cluster 102. For instance, changes to a deployment of an application may input by a developer 120 as changes to the application files 114. Developer 114 is generally any individual or entity granted privileges to modify the application files 114. A file monitor 112 of the deployment node 110 keeps track of changes to the application files 114 (i.e., changes associated with a new deployment of an application). The “agents” 106a-e, 108a-e of the application nodes 104a-e determine which application files 114 are not available to (e.g., stored on or executed by) the application nodes 104a-e. The nodes 104a-e request any missing files via request 130, and the missing files are automatically loaded into the volatile memory of the application nodes 104a-e (e.g., without storing copies in the non-volatile memory of the application nodes 104a-e). The application deployment system 100 may be configured as shown or in any other suitable configuration.

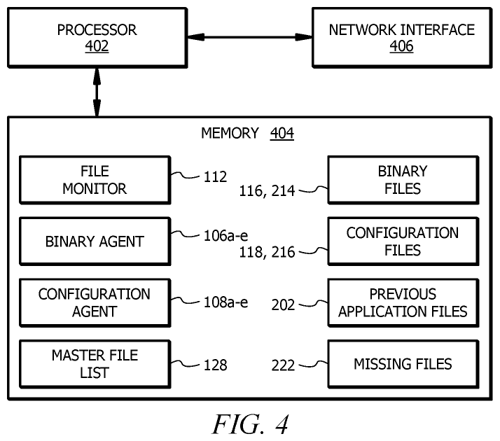

The application cluster 102 is generally configured to distribute tasks associated with executing an application (or a number of applications) across a collection of application nodes 104a-e. While the example of FIG. 1 shows an application cluster 102 with five application nodes 104a-e, it should be understood that the application cluster 102 may include any appropriate number of application nodes 104a-e (e.g., from two to hundreds or more of application nodes 104a-e). Each of the application nodes 104a-e is generally a server or any other computing device which may be configured to execute tasks of an application in a clustered environment (i.e., as part of application cluster 102). Nodes 104a-e are communicatively coupled to each other and to the deployment node 110 and network 126. Each application node 104a-e may be implemented using the hardware, memory, and interface of device 400 described with respect to FIG. 4 below.

The deployment node 110 is generally a server, or any other appropriate computing device, on which one or more applications to be executed on the application cluster 102 are initially “deployed”. In other words, the application is loaded (i.e., application files 114 are loaded) onto the deployment node 110 as if the node 110 were going to execute the application. The deployment system 100 is configured such that whatever application files 114 are present in the volatile memory of the deployment node 110 are automatically replicated into the volatile memory of the application nodes 104a-e. The file monitor 112, which is described in greater detail below, determines when one or more changes have been made to the application files 114 and provides, to the application cluster 102, a master list 128 which includes a record of all application files 114 needed to execute the application. The binary and configuration agents 106a-e, 108a-e of the application nodes 104a-e identify files needed by each node 104a-e and request the missing files by sending file request(s) 130 to the deployment node 110. The missing files are automatically loaded into the volatile memory of the application nodes 104a-e.

The deployment node 110 is generally not part of the application cluster 102 and is typically not involved in the actual execution of the application. Instead, the deployment node 110 acts as a reference for which files 114 are needed by the application nodes 104a-e. In some embodiments, the use of a separate deployment node 110, which is not a part of the application cluster 102, allows updates to an application deployment (e.g., via changes to files 114 by a developer 120) to be performed, while the previous deployment of the application is still executed by the application cluster 102. This results in less down-time when a new deployment of an application is being developed than was possible using previous technology. The deployment node 110 may be implemented using the hardware, memory, and interface of device 400 described with respect to FIG. 4 below.

The application files 114 generally include two main file types, binary files 116 and configuration files 118. The binary files 116 generally include any executable files used to execute processes of an application. For instance the binary files 116 may include code for executing a task of the application. Examples of binary files may include executable (.exe) files, dynamic link library (.dll) files, shell scripts, shared libraries, and the like. Different binary files 116 may be used to execute an application using a given operating system. In contrast, the configuration files 118 generally include any other files needed to implement the function of, or perform tasks with, the application. For instance, configuration files 118 may include static data used to keep an application up and running by the application cluster 102. Configuration files 118 may include information or data used for calculations (e.g., tables of data on which calculations are performed, constant values such as the value of pi used for mathematical functions, and the like). Configuration files 118 may provide references data file locations (e.g., folder locations), point to an appropriate port to perform application processes, identify an endpoint address (e.g., web address), and the like. For instance, configuration files 118 may provide information for fetching data from a database (e.g., name of a currency, amount of currency, e.g., type of mathematical function).

The computing device 122 is generally any computing device (e.g., a computer, smartphone, tablet, or the like) operated by a user 124 in order to interact with the application executed by the application cluster 102. Device 122 is generally coupled to network 126. A user 124 may use device 126 to access and interact with the application executed by the cluster 102. For instance, if the application is a web application (e.g., as in the example described below). The user 124 may input a web address in the device 122, and the information presented to the user 124 via a display of device 122 may be determined and provided by the application cluster 102. Device 122 may be implemented using the hardware, memory, and interfaces of device 400 described with respect to FIG. 4 below.

Network 126 facilitates communication between and amongst the various components of the application deployment system 100. This disclosure contemplates network 126 being any suitable network operable to facilitate communication between the components of the system 100. Network 126 may include any interconnecting system capable of transmitting audio, video, signals, data, messages, or any combination of the preceding. Network 126 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

In an example operation of the application deployment system 100, a web application is executed by the application cluster 102. User 124 accesses and interacts with the web application using device 122. For example, the user 124 may input a web address in the device 122 and be presented with the corresponding web application executed by the application cluster 102. While the user 124 is accessing the web application, a developer 120 may wish to modify the web application by configuring a new deployment of the application at the deployment node 110. For example, the developer 120 may configure the new deployment by changing (e.g., editing, adding, and/or removing) application files 114. For instance, binary files 116 and/or configuration files 118 may be changed, removed and/or added to configure the dew deployment of the application. In general, the user 124 is able to use the previous deployment of the application while the developer 120 configures the new deployment at the deployment node 110.

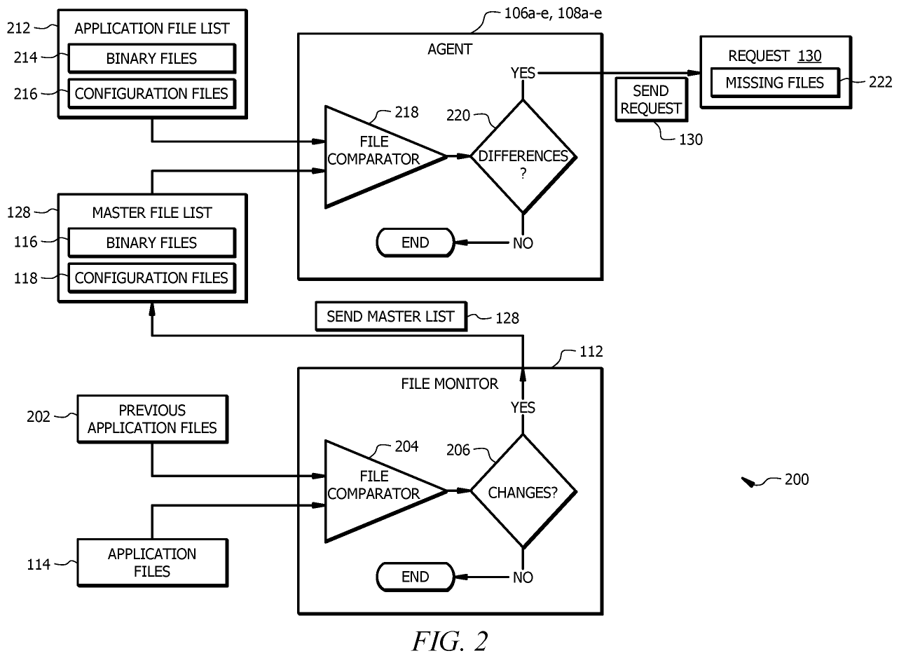

FIG. 2 is a flow diagram illustrating how the file monitor 112 of the deployment node 110 and agents 106a-e, 108a-e of the application nodes 104a-e work together to detect and implement changes to the deployment by efficiently propagating these changes to the application cluster 102. For example, the file monitor 112 may compare the recently updated application files 114 to previous application files 202. For instance, a file comparator 204 may compare the application files 114 to the previous files 202 in order to provide a determination 206 of whether there are any changes to the application files 114. If there are no changes to application files 114 (i.e., if the application files 114 are the same as the previous application files 202), the file monitor 112 generally does not interact with the application cluster 102 at this time. For instance, the file monitor 112 may wait some predetermined delay time (e.g., of seconds, minutes, hours, days, or the like) before another comparison is made. In some embodiments, the comparison described above is initiated by the developer 120 (e.g., via input of an appropriate command following completion of changes to the application deployment).

If changes are detected by the file comparator 204 (i.e., the changes input by developer 120 in this example), the deployment node 110 sends the master list 128 to the application cluster 102. The master list 128 generally includes a list of the binary files 116 and configuration files 118 on the deployment node 110. In other words, the master list 128 is generally a list of the names, or other appropriate identifiers, of the application files 114. Each of the application nodes 104a-e of the application cluster 102 receives the master list 128. Each of the agents 106a-e, 108a-e of the application nodes 104a-e compares the master list 128 to a list 212 of application files available to the application node 104a-e. The application file list 212 for a given application node 104a-e includes a list of the binary files 214 and configuration files 216 available to the node 104a-e. The available files 212 may be the files loaded to the volatile memory of the node 104a-e.

A comparator 218 of each of the agents 106a-e, 108a-e compares the application files 212 of the corresponding node 104a-e to the master list 128 to provide a determination 220 of whether there are differences between the master list 128 and the application file list 212. If there are no differences, the agent 106a-e, 108a-e generally takes no further action because no files need to be added, removed, or otherwise modified from the volatile memory of the application node 104a-e.

However, if differences are detected by the file comparator 218, the agent 106a-e, 108a-e determines whether files need to be added or removed from the volatile memory of the application node 104a-e. For example, the new deployment of the application may involve the removal of a file from application list 114. In this example case, the agent 106a-e, 108a-e may cause this file to be removed from the volatile memory of the application node 104a-e. In some cases, the file comparator 218 identifies one or more missing files 222, which correspond to files that are not in the volatile memory of the application node 104a-e but appear in the master list 128. In general, the missing file(s) 222 determined for the first application node 104a may be different from the missing file(s) 222 determined for any one or more of the other application nodes 104b-e. Each application node 104a-e generally transmits request 130 to the deployment node 110. Each request 130 includes an indication of the missing files 222 needed by the corresponding application node 104a-e. Upon receiving the request 130, the deployment node 110 may cause the missing files 222 to be loaded into the volatile memory of the application node 104a-e. For instance, the missing files 222 may be sent to the application node 104a-e and loaded in the volatile memory of the node 104a-e. In a typical embodiment, the missing files are not saved in the non-volatile memory (e.g., ROM) of the application node 104a-e. Once the missing files 22 are loaded to the volatile memory of each of the application nodes 104a-e, the new deployment is generally available for use by user 124. By following the approach described above with respect to FIG. 2, there is little or no down-time during which an application is not available when a new application is developed and deployed.

### Example Method of Operating the Application Deployment System

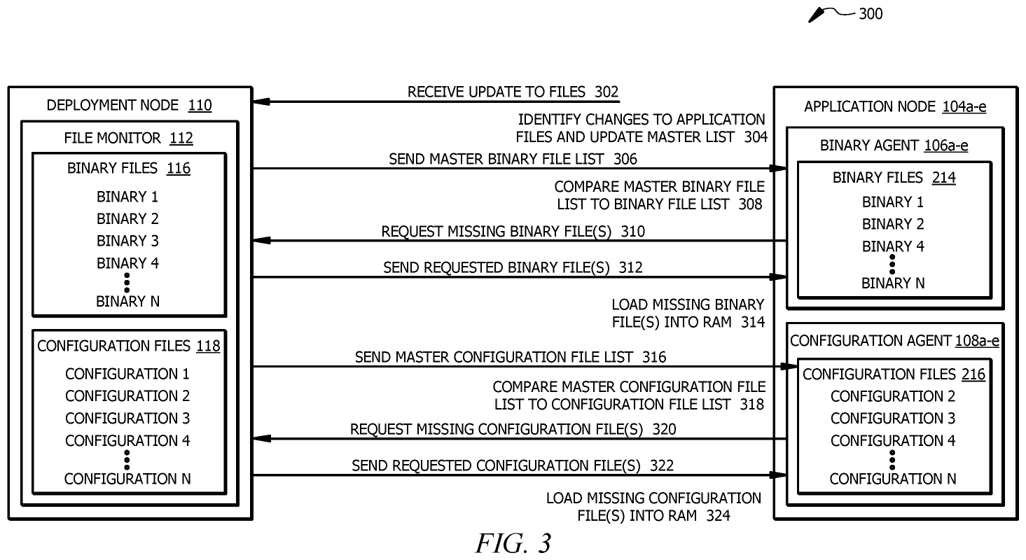

FIG. 3 is a flow diagram illustrating an example method 300 of operating the application deployment system 100 shown in FIG. 1. In this example, the file monitor 112 stores or otherwise accesses a list of binary files 116 (including binary files “binary 1,” “binary 2,” “binary 3,” “binary 4,” and up to “binary n”) and a list of configuration files 118 including configuration files “configuration 1,” “configuration 2,” “configuration 3,” “configuration 4,” and up to “configuration n”). The application node 104a-e includes a binary agent 106a-e which stores or otherwise access a list of binary files 214 available to (e.g., loaded in the volatile memory of) the application node 104a-e. The binary files 214 include files “binary 1,” “binary 2,” “binary 4,” and up to “binary n.” Accordingly, the application node 104a-e is missing at least file “binary 3,” which appears in the list of binary files 116 at the deployment node 110 but not in the list of binary files 214. The application node 104a-e also includes a configuration agent 108a-e which stores or otherwise access a list of configuration files 216 available to (e.g., loaded in the volatile memory of) the application node 104a-e. The configuration files 216 include files “configuration 2,” “configuration 3,” “configuration 4,” and up to “configuration n.” Accordingly, the application node 104a-e is missing at least file “configuration 1” which appears in the list of configuration files 118 at the deployment node 110 but not in the list of configuration files 216.

Method 300 may begin at step 302, where the deployment node 110 receives an update to the application files 114. For example, the developer 120 (e.g., or any other appropriate individual or entity) may make changes to the application files 114. The changes may correspond to a new or updated deployment of an application that is to be executed by the application cluster 102. The update or changes to the application files 114 may corresponds to a change from a previous deployment of the application to a new deployment of the application. In some embodiments, one or more of the application nodes 104a-e may continue to execute the previous deployment of the application while the deployment node 110 receives updates at step 302. This may facilitate updates to a deployment of an application while allowing the application to still be used (e.g., by user 124 of FIG.1). Using previous technology, applications executed in a clustered environment were typically unavailable to users while a new deployment was configured.

At step 304, the deployment node 110 detects and identifies changes made to the application files 114 and generates the master list 128 to send to the application cluster 102. The change may correspond to a modification to one or more processes to be performed by the application (e.g., to changes to one or more of files 114 associated with a new deployment of the application). The file monitor 112 may detect the changes to the application files 114 by comparing the application files 114 to previous application files 202, as described above with respect to FIG. 2. This comparison may be performed at regular intervals (e.g., hourly, daily, or the like). This comparison may be initiated by a command received from the developer 120 (e.g., or any other appropriate individual or entity). The master list is generated, or updated, to include the most current application files 114 following the update at step 302. For example, the master list 128 may be updated automatically

At step 306, the deployment node 110 transmits a master binary file list to each of the application nodes 104a-e. The list may be transmitted automatically upon being updated at step 304. The master binary file list generally corresponds to the portion of the master file list 128 and includes binary files 116 associated with the deployment node 110. In some embodiments, the master binary file list may be transmitted as a single master list 128, and the application node 104a-e receiving the list 128 may be configured to identify the binary files 116 in the list (e.g., based on file names and/or file types). For instance, executable files (e.g., .exe files, .dll files, and the like) may be identified as binary files 116 in master list 128.

At step 308, the binary agent 106a-e compares the master binary file list to a list of binary files 214 available to the application node 104a-e. Based on this comparison, the binary agent 106a-e identifies missing files 222, which need to be loaded on the application node 104a-e in order to implement the new deployment of the application. In this example, the missing binary file 222 corresponds to the file “binary 3.” At step 310, the application node 104a-e transmits a request 130 for the missing file “binary 3” to the deployment node 110. At step 312, the deployment node 110 sends the missing file “binary 3” to the application node 104a-e. At step 314 the missing file “binary 3” is loaded into the volatile memory of the application node 104a-e. The binary file “binary 3” may be loaded automatically into the volatile memory (e.g., following being received by the application node 104a-e). In other words, the “binary 3” file is loaded directly into the volatile memory of the application node 104a-e so that it is nearly instantaneously available for execution in the new deployment of the application (e.g., rather than being copied to non-volatile memory of the node 104a-e).

Similar steps to those described above may be employed to identify missing configuration files 118 which are needed to execute the new deployment of the application by the application node 104a-e. For example, at step 316, a list of configuration files 118 may be transmitted from the deployment node 110. At step 318, the configuration agent 108a-e compares the list of configuration files 118 list to a list of configuration files 216 available to the application node 104a-e. Based on this comparison, the configuration agent 108a-e identifies missing files 222, which need to be loaded on the application node 104a-e in order to implement the new deployment of the application. In this example, the missing configuration file 222 corresponds to the file “configuration 1.” At step 320, the application node 104a-e transmits a request 130 for the missing file “configuration 1” to the deployment node 110. At step 322, the deployment node 110 sends the missing file “configuration 1” to the application node 104a-e. At step 324 the missing configuration file “configuration 1” is loaded (e.g., automatically) into the volatile memory of the application node 104a-e. Generally, during this process, the “configuration 1” file is not stored in non-volatile memory of the application node 104a-e.

While in the example method 300 described above a list of binary files 116 and a list of configuration files 118 are sent in separate steps 306 and 316, these lists may be sent in a single step as a single master list 128. For example, the application node 104a-e (i.e., the binary agent 106a-e and the configuration agent 108a-e) may determine which files of the master list 128 correspond to binary files 116 and which correspond to configuration files 118 (e.g., based on file names, file types, etc.).

### Example Devices for Implementing the Application Deployment System

FIG. 4 is an embodiment of a device 400 configured to implement the application deployment system 100, illustrated in FIG. 1. The device 400 includes a processor 402, a memory 404, and a network interface 406. The device 400 may be configured as shown or in any other suitable configuration. The device 400 may be and/or may be used to implement any one or more of the application nodes 104a-e, the deployment node 110, and the computing device 122 of FIG. 1.

The processor 402 includes one or more processors operably coupled to the memory 404. The processor 402 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 402 may be a programmable logic device, a microcontroller, a microprocessor, or any suitable combination of the preceding. The processor 402 is communicatively coupled to and in signal communication with the memory 404 and the network interface 406. The one or more processors are configured to process data and may be implemented in hardware or software. For example, the processor 402 may be 8-bit, 16-bit, 32-bit, 64-bit or of any other suitable architecture. The processor 402 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions to implement the function disclosed herein, such as some or all of method 300. In an embodiment, the function described herein is implemented using logic units, FPGAs, ASICs, DSPs, or any other suitable hardware or electronic circuitry.

The memory 404 is operable to store data for implementing file monitor 112, data for implementing binary agent(s) 106a-e, data for implementing configuration agent(s) 108a-e, list(s) 128, binary files 116, 214, configuration files 118, 216, previous application files 202, missing files 222, and/or any other data or instructions. The instructions may include any suitable set logic, rules, or code operable to execute the function described herein. The memory 404 includes one or more disks, tape drives, or solid-state drives, and may be used as an over-flow data storage device, to store programs when such programs are selected for execution, and to store instructions and data that are read during program execution. The memory 404 may be volatile or non-volatile and may comprise read-only memory (ROM), random-access memory (RAM), ternary content-addressable memory (TCAM), dynamic random-access memory (DRAM), and static random-access memory (SRAM). As described above, in certain embodiments, the binary files 116, 214 and configuration files 118, 216 are loaded directly into the volatile memory of the application nodes 104a-e. As such, in some embodiments, the application nodes 104a-e may not include a copy of one or more of the binary files 116, 214 and/or configuration files 118, 216 in non-volatile memory.

The data for implementing file monitor 112 may include any necessary instructions logic, rules, or code operable to execute the function of the file monitor 112 described above with respect to FIGS. 1 and 2. For instance, the data for file monitor 112 may be used implement the file comparator 204 described with respect to FIG. 2 above. Likewise, the data for implementing binary agent(s) 106a-e and configuration agent(s) 108a-e generally include any necessary instructions logic, rules, or code operable to execute the functions of the binary agents 106a-e and configuration agents 108a-e described above with respect to FIGS. 1 and 2. For instance, the data for binary agents 106a-e and configuration agents 108a-e may be used implement the file comparator 218 described with respect to FIG. 2 above. The master file list 128 generally includes the application files 114 associated with a new deployment of an application and is described above with respect to FIG. 1. The binary files 116, 214, configuration files 118, 216 are described above with respect to FIGS. 1 and 2. The previous application files 202 and missing files 222 are described above with respect to FIG. 2.

The network interface 406 is configured to enable wired and/or wireless communications (e.g., via network 126). The network interface 406 is configured to communicate data between the device 400 and other network devices, systems, or domain(s). For example, the network interface 406 may comprise a WIFI interface, a local area network (LAN) interface, a wide area network (WAN) interface, a modem, a switch, or a router. The processor 402 is configured to send and receive data using the network interface 406. The network interface 406 may be configured to use any suitable type of communication protocol as would be appreciated by one of ordinary skill in the art.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A system comprising:
a deployment node configured to:
generate a master list of files associated with executing an application;
transmit the master list to a plurality of application nodes; and
the plurality of application nodes configured to execute the application, the plurality of application nodes comprising a first application node, wherein the first application node is configured to:
receive the master list;
determine a first file not available to the first application node by comparing the master list to a first local file list, the first local file list comprising a record of files which are one or both of stored on and executed by the first application node;
transmit, to the deployment node, a request for the first file;
the deployment node further configured to:
receive the request for the first file;
transmit the first file to the first application node; and
the first application node further configured to load the first file into volatile memory of the first application node.

2. The system of claim 1, the plurality of application nodes comprising a second application node, the second application node of the plurality of application nodes is configured to:
receive the master list;
determine a second file not available to the second application node by comparing the master list to a second local file list, the second local file list comprising a record of files which are one or both of stored on and executed by the second application node, wherein the second file is different than the first file;
transmit, to the deployment node, a request for the second file;
the deployment node further configured to:
receive the request for the second file;
transmit the second file to the second application node; and
the second application node further configured to automatically load the second file into the volatile memory of the second application node.

3. The system of claim 1, the deployment node comprising a file monitor configured to:
detect a change to the files associated with executing the application, wherein the change corresponds to a modification to one or more processes to be performed by the application;
in response to detecting the changes, automatically update the master list to reflect the change; and
automatically transmit the updated master list to the plurality of application nodes.

4. The system of claim 1, the first application node comprising:
a binary agent configured to:
identify, by comparing the first local file list to the master list, a binary file needed by the first application node to execute the application;
transmit a request for the binary file to the deployment node; and
automatically load the binary file into the volatile memory of the first application node; and
a configuration agent configured to:
identify, by comparing the first local file list to the master list, a configuration file needed by the first application node to perform a calculation using the application;
transmit a request for the configuration file to the deployment node; and
automatically load the configuration file into the volatile memory of the first application node.

5. The system of claim 1, wherein the first file is a binary file comprising code for executing a task of the application.

6. The system of claim 1, wherein the first file is a configuration file comprising static data for implementing a task by the application.

7. The system of claim 1, wherein:
the deployment node is further configured to receive an update to the files associated with executing the application, wherein the update corresponds to a change from a previous deployment of the application to a new deployment of the application; and
the first application node is further configured to, while the deployment node receives the update, continue to execute the previous deployment of the application.

8. A method comprising:
executing an application on a plurality of application nodes, the plurality of application nodes comprising a first application node;
receiving, from a deployment node communicatively coupled to the plurality of application nodes, a master list of files associated with executing an application;
determining a first file not available to a first application node by comparing the master list to a first local file list, the first local file list comprising a record of files which are one or both of stored on and executed by the first application node;
transmitting, to the deployment node, a request for the first file; and
loading the first file into volatile memory of the first application node.

9. The method of claim 8, further comprising:
determining a second file not available to a second application node of the plurality of application nodes by comparing the master list to a second local file list, the second local file list comprising a record of files which are one or both of stored on and executed by the second application node, wherein the second file is different than the first file;
transmitting, to the deployment node, a request for the second file;
automatically loading the second file into volatile memory of the second application node.

10. The method of claim 8, further comprising:
detecting, by the deployment node, a change to the files associated with executing the application, wherein the change corresponds to a modification to one or more processes to be performed by the application;
in response to detecting the changes, automatically updating, by the deployment node, the master list to reflect the change; and
automatically transmitting, by the deployment node, the updated master list to the plurality of application nodes.

11. The method of claim 8, further comprising:
identifying, by comparing the first local file list to the master list, a binary file needed by the first application node to execute the application;
transmitting a request for the binary file to the deployment node; and
automatically loading the binary file into the volatile memory of the first application node;
identifying, by comparing the first local file list to the master list, a configuration file needed by the first application node to perform a calculation using the application;
transmitting a request for the configuration file to the deployment node; and
automatically loading the configuration file into the volatile memory of the first application node.

12. The method of claim 8, wherein the first file is a binary file comprising code for executing a task of the application.

13. The method of claim 8, wherein the first file is a configuration file comprising static data for implementing a task by the application.

14. The method of claim 8, further comprising continuing to execute a previous deployment of the application while the deployment node receives an update corresponding to a new deployment of the application.

15. A device configured to:
generate a master list of files associated with executing an application;
transmit the master list to a plurality of application nodes, wherein the plurality of application nodes are configured to execute the application;
receive, from a first application node of the plurality of application nodes, a request for a first file, wherein the first file is a file which is not available to the first application node and is associated with executing the application; and
transmit the first file to the first application node, thereby facilitating loading of the first file into volatile memory of the first application node.

16. The device of claim 15, the device further configured to:
receive, from a second application node of the plurality of application nodes, a request for a second file, wherein the second file is a file which is not available to the second application node and is needed to execute the application, wherein the second file is different than the first file; and
transmit the second file to the second application node, thereby facilitating loading of the second file into volatile memory of the second application node.

17. The device of claim 15, further comprising a file monitor configured to:
detect a change to files associated with executing the application, wherein the change corresponds to a modification to one or more processes to be performed by the application;
in response to detecting the changes, automatically update the master list to reflect the change; and
automatically transmit the updated master list to the plurality of application nodes.

18. The device of claim 15, wherein the file is a binary file comprising code for executing a task of the application.

19. The device of claim 15, wherein the file is a configuration file comprising static data for implementing a task by the application.

20. The device of claim 15, further configured to,
receive an update to the files associated with executing the application while the application is executed on the plurality of application nodes, wherein the update corresponds to a change from a previous deployment of the application to a new deployment of the application.
